(19) United States
(12) Patent Application Publication
(10) Pub. No.: US 2013/0064511 A1
(43) Pub. Date: Mar. 14, 2013

(54) OPTICAL MODULE AND METHOD OF MANUFACTURING THE SAME

(71) Applicants: Michihiko NISHIGAKI, Kawasaki-shi (JP); Hideto Furuyama, Yokohama-shi (JP)

(72) Inventors: Michihiko NISHIGAKI, Kawasaki-shi (JP); Hideto Furuyama, Yokohama-shi (JP)

(21) Appl. No.: 13/552,082

(22) Filed: Jul. 18, 2012

(30) Foreign Application Priority Data
Sep. 13, 2011 (JP) 2011-199696

(51) Int. Cl. G02B 6/36; G02B 6/25

(52) U.S. Cl. 385/88; 29/464

(57) ABSTRACT

According to one embodiment, an optical module includes an optical fiber, a ferrule which has a guide hole, a planar photonic device which is mounted on the ferrule, and a sleeve which includes a holding part for holding the optical fiber and a bumping part for making contact with one end of the ferrule and to which the optical fiber and the ferrule are fixed. The optical fiber is fixed to the sleeve in such a manner that the optical fiber protrudes from one end of the sleeve and has an end face formed using one end of the sleeve as a reference. The optical fiber with the formed end face is inserted in the guide hole in the ferrule and the ferrule is fixed to the sleeve with one end of the ferrule in contact with the bumping part of the sleeve.

### CROSS-REFERENCE TO RELATED APPLICATIONS

This application is based upon and claims the benefit of priority from prior Japanese Patent Application No. 2011-199696, filed Sep. 13, 2011, the entire contents of which are incorporated herein by reference.

### FIELD

Embodiments described herein relate generally to an optical module and a method of manufacturing the same.

### BACKGROUND

In recent years, an optical module for an optical interconnection system using an optical waveguide, such as an optical fiber, has been proposed.

In this type of optical module, to optically couple a planar photonic device with an optical fiber, the optical fiber is often positioned with a ferrule. Positioning in a direction perpendicular to the optical axis of the optical fiber can be performed through a guide hole in the ferrule. In positioning in an optical axis direction, the end face of the optical fiber inserted in the ferrule needs to be formed in a specific place. In addition, to suppress the deviation of the optical axis due to a warp in the optical fiber or the deformation of the optical fiber caused by a sealing action, the end face of the optical fiber is often aligned with the end face of the ferrule. In this case, however, it is impossible to use such an apparatus as an optical fiber cleaver or a laser cutting machine capable of forming the end face of the optical fiber simply and easily. Therefore, it is necessary to form the end face of the optical fiber by polishing processing whose tact time is long and whose processing cost is relatively high.

In the case of a ferrule provided with a planar photonic device, the end face of the optical fiber needs to be arranged in a specific position inside the ferrule. Normally, to prevent the destruction of a planar photonic device caused by contact with an optical fiber, the end face of the optical fiber is arranged away from the planar photonic device. At this time, if they are separated too much, the efficiency of optical coupling between the planar photonic device and the optical fiber decreases. Therefore, the end face of the optical fiber is arranged only a short distance from the planar photonic device. However, the distance between the end face of the optical fiber and the planar photonic device is as little as several micrometers to hundreds of micrometers. Therefore, it is necessary to prepare a high-accuracy positioning device to arrange the end face of an optical fiber in a specific position.

### BRIEF DESCRIPTION OF THE DRAWINGS

FIG. 1 is a plan view showing a schematic configuration of an optical module according to a first embodiment;

FIG. 2 is a sectional view taken along line A-A′ in FIG. 1;

FIGS. 3A and 3B are sectional views showing a schematic configuration of a ferrule to explain a method of manufacturing an optical module according to the first embodiment;

FIGS. 4A to 4C are sectional views showing a schematic configuration of a sleeve to explain the method of manufacturing the optical fiber according to the first embodiment;

FIG. 5 is a perspective view of an example of ferrules formed in an array;

FIG. 6 is a plan view to explain the effect of the first embodiment, showing a case where there is no ferrule internal mounting part;

FIGS. 7A to 7C are sectional views showing the structures of ferrules and sleeves;

FIG. 8 is a sectional view showing an example of a photonic device mounting face of the ferrule inclined with respect to the optical axis of an optical fiber:

FIG. 9 is a sectional view showing a schematic configuration of an optical module according to a second embodiment;

FIGS. 10A to 10D are sectional views showing configurations of ferrules to explain an optical module according to a third embodiment;

FIG. 11 is a sectional view showing a schematic configuration of an optical module according to a fourth embodiment;

FIGS. 12A and 12B are a sectional view and a plan view respectively, showing a schematic configuration of an optical module according to a fifth embodiment; and

FIGS. 13A and 13B are a sectional view and a plan view respectively, showing a schematic configuration of an optical module according to a sixth embodiment.

### DETAILED DESCRIPTION

In general, according to one embodiment, an optical module includes an optical fiber, a ferrule which has a guide hole for performing alignment in a direction perpendicular to the optical axis of the optical fiber, a planar photonic device which is mounted on the ferrule, and a sleeve which includes a holding part for holding the optical fiber and a bumping part for making contact with one end of the ferrule and to which the optical fiber and the ferrule are fixed. The optical fiber is fixed to the sleeve in such a manner that the optical fiber protrudes from one end of the sleeve and has an end face formed using one end of the sleeve as a reference. The optical fiber with the formed end face is inserted in the guide hole in the ferrule and the ferrule is fixed to the sleeve with one end of the ferrule in contact with the bumping part of the sleeve. This causes the end face of the optical fiber to be aligned with the planar photonic device in an optical axis direction.

Hereinafter, referring to the accompanying drawings, embodiments will be explained. In the drawings, the same or like parts are indicated by the same or like reference numbers. The drawings are represented schematically and therefore it should be noted that the relationship between the thickness and the plane dimensions, the proportions of the thicknesses of the individual layers, and others differ from actual ones. Therefore, practical thicknesses and dimensions should be determined, taking into account an explanation given below. It goes without saying that the drawings include parts differing from one another in the relationship between dimensions or the proportions of dimensions.

### First Embodiment

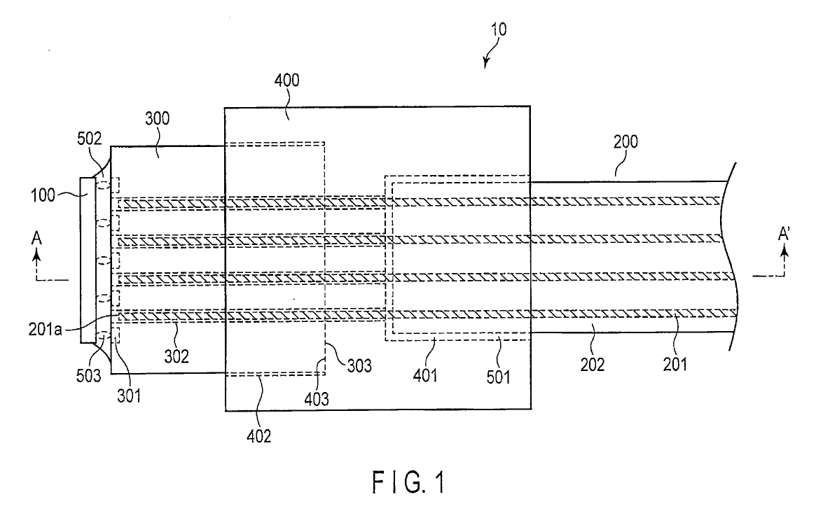

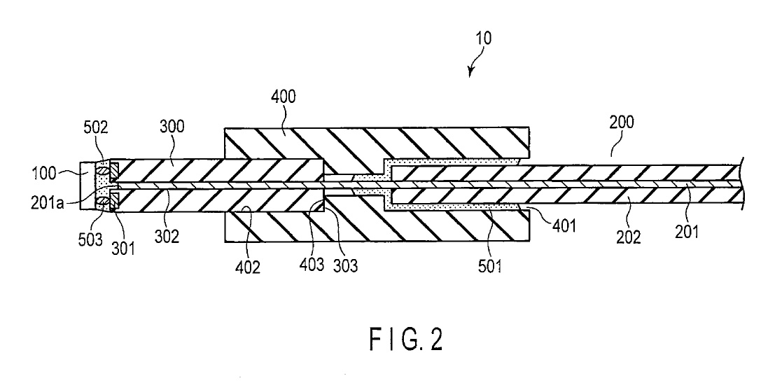

FIGS. 1 and 2 are diagrams to explain a schematic configuration of an optical module 10 according to a first embodiment. FIG. 1 is a plan view and FIG. 2 is a sectional view taken along line A-A′ in FIG. 1.

The optical module 10 comprises a planar photonic device 100, an optical fiber 200, a ferrule 300 in which electric wiring 301 and guide holes 302 have been made, and a sleeve 400 in which a fiber holding part 401 and a ferrule internal mounting part 402 have been formed.

The planar photonic device 100 is, for example, a vertical cavity surface emitting laser (VCSEL). The planar photonic device 100 is mounted on the ferrule 300 so that the center of its light exit aperture may align almost with the center of the guide hole 302 made in the ferrule 300. Specifically, the planar photonic device 100 is connected to the electric wiring 301 formed at the ferrule 300 via photonic device mounting bumps 503 of gold. Therefore, a light beam emitted from the planar photonic device 100 can be coupled with almost the center of a core line 201 of the optical fiber 200 inserted in the guide hole 302. In addition, the planar photonic device 100 is configured to be capable of being driven via the electric wiring 301.

In the optical fiber 200, the core line 201 is silica glass multimode graded index (GI) fiber (having a core diameter of 50 μm and an outside diameter of 125 μm). The optical fiber 200 is configured to have a four-channel ribbon structure using a coating 202. At the tip part of the optical fiber 200, the coating 202 is removed to be fixed to the sleeve 400 and inserted in the guide hole 302 made in the ferrule 30, with the core line 201 being exposed.

The ferrule 300, which is made of epoxy resin mixed with about 80% glass filler of about 30 μm, is formed into a rectangular parallelepiped by shape forming with a die. The guide hole 302 made in the ferrule 300 has a circular form, almost the same as the external form of a core line 201 of the optical fiber 200. With this form, an end face 201a of the core line 201 of the optical fiber 200 is configured to be positioned in a direction perpendicular to the optical axis of the optical fiber 200. At one face of the ferrule 300, specifically at the photonic device mounting face in which one aperture of the guide hole 302 lies, the electric wiring 301 is formed by pattern metallization using a metal mask and sputtering techniques. At the face opposite to the photonic device mounting face of the ferrule 300, a sleeve bumping part 303 is formed.

Like the ferrule 300, the sleeve 400, which is made of epoxy resin mixed with about 80% glass filler of about 30 μm, is formed by shape forming with a die. In the sleeve 400, a fiber holding part 401 for holding an optical fiber is formed. The coating 202 of the optical fiber 200 is held by the fiber holding part 401 via a first adhesive 501 of thermosetting epoxy. Moreover, in the sleeve 400, a ferrule internal mounting part 402 in which the ferrule 300 is to be internally mounted, that is, a part of the ferrule 300 is to be inserted, is formed. In the ferrule internal mounting part 402, the ferrule bumping part 403 is formed.

When the ferrule 300 is internally mounted in the ferrule internal mounting part 402, the core line 201 of the optical fiber 200 is inserted into the guide hole 302 of the ferrule 300. This positions the end face 201a of the core line 201 in a direction perpendicular to the optical axis of the optical fiber 200. The area of the ferrule 300 internally mounted in the ferrule internal mounting part 402 and the cross-sectional shape of each ferrule internal mounting part 402 are configured to take a shape that prevents the ferrule 300 from slipping carelessly when the ferrule 300 is internally mounted. This causes positioning to be performed in a direction perpendicular to the optical axis of the ferrule 300. In addition, when the ferrule bumping part 403 and sleeve bumping part 303 butt each other when the ferrule 300 is internally mounted, this causes positioning to be performed in a direction of the optical axis of the ferrule 300.

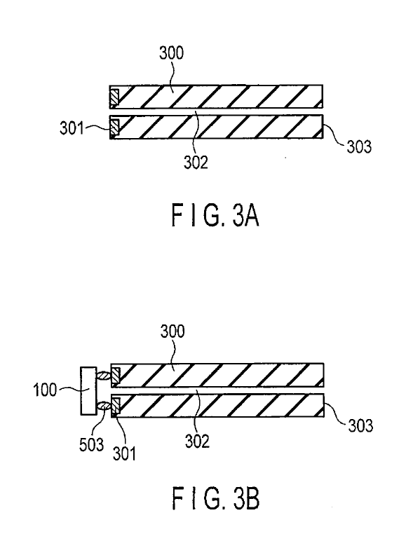

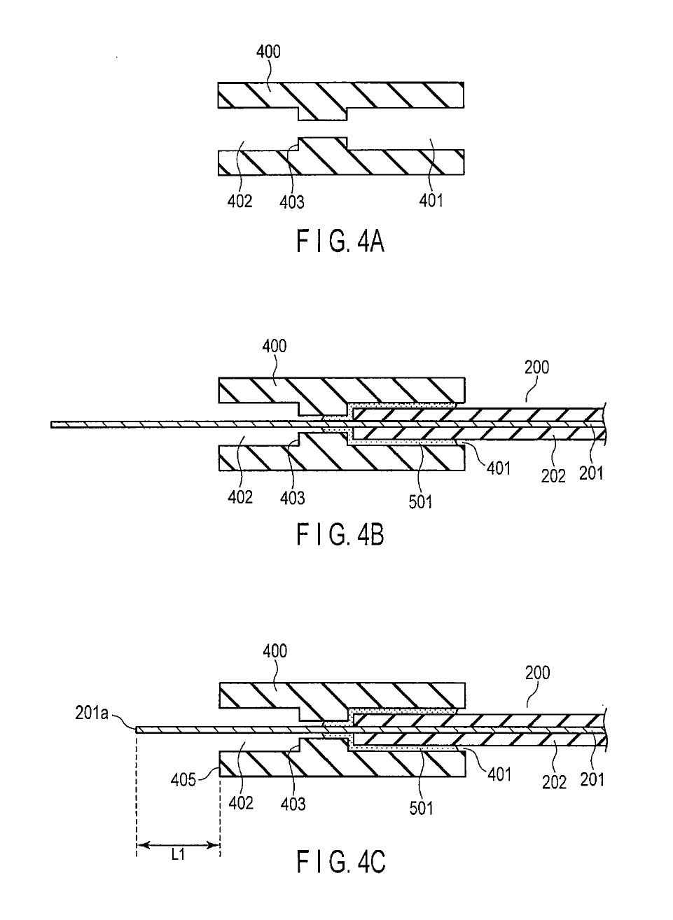

Next, a method of manufacturing the optical module 10 according to the first embodiment will be explained with reference to FIGS. 3A and 3B and FIGS. 4A to 4C.

FIG. 3A is a schematic sectional view of the ferrule 300. As described above, the electric wiring 301 is formed at the photonic device mounting face of the ferrule 300. A sleeve bumping part 303 is formed at the face opposite to the photonic device mounting face. A guide hole 302 passing through the ferrule from the photonic device mounting face to the sleeve bumping part 303 is made.

FIG. 3B shows a state where a planar photonic device 100 is mounted on the ferrule 300. The planar photonic device 100 is mounted on the electric wiring 301 of the ferrule 300 by thermocompression bonding via photonic device bumps 503.

The shape forming of the ferrule 300 can be performed by fitting a die in one direction. Therefore, as shown in FIG. 5, it is possible not only to produce ferrules 300 in an array but also to mount planar photonic devices 100 on the ferrules arranged in an array. That is, a large number of ferrules 300 can be produced and planar photonic devices 100 can be mounted consecutively. This enables the manufacturing time to be shortened remarkably. The ferrules 300 can be segmented by cutting the ferrules at specific cutting positions 305 by dicing techniques or the like.

FIG. 4A is a schematic sectional view of the sleeve 400. As described above, in the sleeve 400, a fiber holding part 401 and a ferrule internal mounting part 402 are formed. In the ferrule internal mounting part 402, a ferrule bumping part 403 is formed.

FIG. 4B shows a state where an optical fiber 200 is held in the fiber holding part 401 of the sleeve 400. An optical fiber 200 with the coating 202 at the tip part removed is inserted into the sleeve 400 in such a manner that a part of the removed area projects from the sleeve 400. After that, the fiber holding part 401 and optical fiber 200 are joined with the first adhesive 501, thereby holding the optical fiber 200 in the sleeve 400.

FIG. 4C shows a step of forming an end face 201a of the optical fiber 200 held in the sleeve 400. The end face 201a is formed a distance of L1 away from a reference end face 405 of the sleeve 400. The end face 201a is formed by use of an optical fiber cleaver or a laser cutting machine. After the core line 201 of the optical fiber 200 has been fixed to the sleeve 400, an end face is formed making use of the reference end face 405. Therefore, the position in which the end face 201a is to be formed is determined uniquely. Here, a part of the core line 201 projects from the sleeve 400. Therefore, there is no need to use high cost polishing processing and a method of forming an end face at a low cost in a short tact time can be used.

FIG. 2 shows a state where the ferrule 300 is internally mounted in the ferrule internal mounting part 402 of the sleeve 400. First, the core line 201 is inserted in the guide hole 302 of the ferrule 300. The ferrule 300 is internally mounted in the ferrule internal mounting part 402, while the core line 201 is being guided. Finally, the sleeve bumping part 303 is caused to butt the ferrule bumping part 403. By doing this, the guide hole 302 causes the end face 201a to be aligned in a direction perpendicular to the optical axis of the optical fiber 200. In addition, the alignment of the ferrule 300 in the optical axis direction is performed by causing the sleeve bumping part 303 and ferrule bumping part 403 to butt each other. As described above, the end face 201a is formed in a position a distance of L1 away from the reference end face 405. As a result, the position of the end face 201a inserted in the ferrule 300 can be determined uniquely, even if a special precision alignment device is not used.

Finally, the core line 201 of the optical fiber 200 and the ferrule 300 are fixed to each other with a second adhesive 502. The ferrule 300 and the sleeve 400 are fixed to each other with the second adhesive 502. Even if the second adhesive 502 is applied before the core line 201 is inserted in the guide hole 302 and the ferrule 300 is internally mounted in the ferrule internal mounting part 402, there is no problem.

As described above, with the optical module 100 of the first embodiment, the alignment of the end face 201a of the optical fiber 200 in the optical axis direction can be performed by neither introducing a high cost polishing process nor requiring a precision alignment device. Therefore, its industrial value is very high.

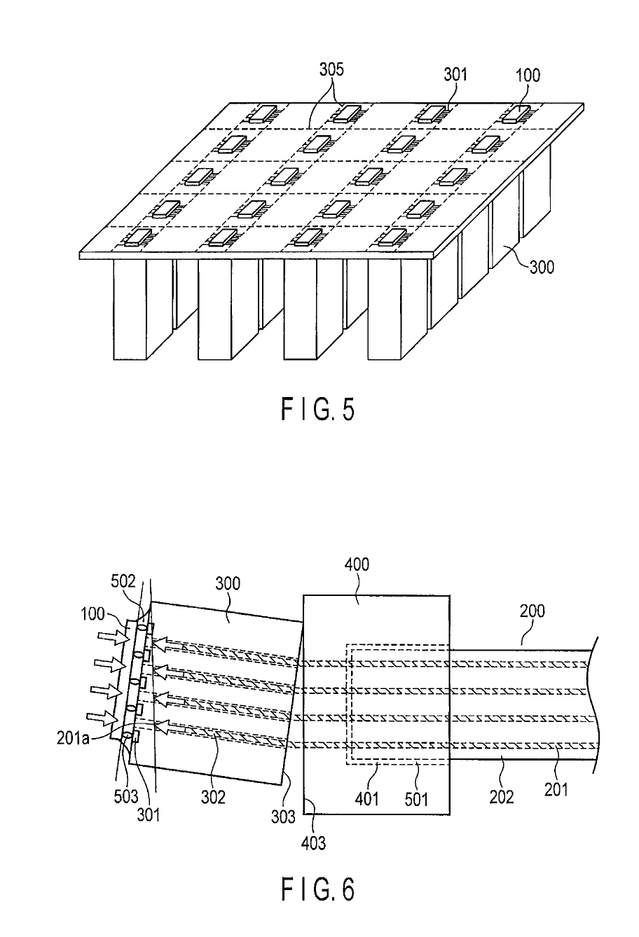

Here, the reason why the ferrule 300 is internally mounted in the ferrule internal mounting part 402 will be explained. If only the alignment of the end face 201a of the optical fiber 200 in the optical axis direction is performed, only the ferrule bumping part 403 is needed and the ferrule internal mounting part 402 is not required. However, if there is no ferrule internal mounting part 402 as shown in FIG. 6, the ferrule 300 cannot be aligned in a direction perpendicular to the optical axis of the optical fiber 200. As a result, the ferrule 300 and sleeve 400 might go into misalignment. When such misalignment has occurred, the distance between the end face 201a and the light exit aperture of the planar photonic device 100 differs from one end face to another. Therefore, the optical coupling characteristic varies from one end face to another.

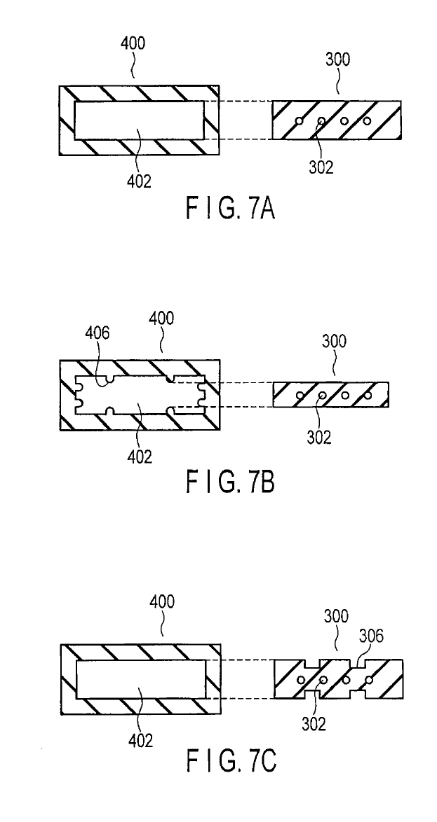

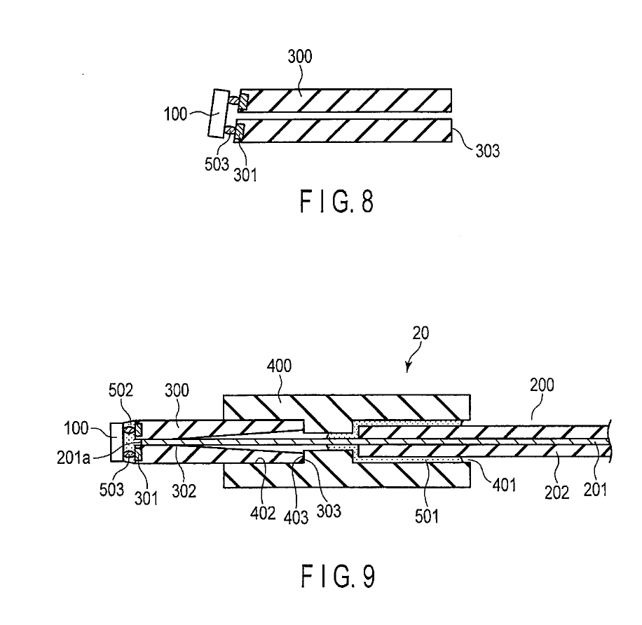

To avoid such a problem, the ferrule 300 is configured to be internally mounted in the ferrule internal mounting part 402. The cross-sectional structure of the area of the ferrule 300 internally mounted in the ferrule internal mounting part 402 and that of the ferrule internal mounting part 402 may be almost in the same shape as shown in FIG. 7A. Alternatively, the ferrule internal mounting part 402 of the sleeve 400 may have convex parts 406 as shown in FIG. 7B. In addition, the ferrule 300 has concave parts in its external surfaces as shown in FIG. 7C. The shapes of FIGS. 78 and 7C are characterized in that it is easy to cause the second adhesive 502 to flow in the ferrule internal mounting part 402 when the ferrule 300 is fixed to the sleeve 400. For the above reasons, it is desirable that the ferrule 300 should be configured to be internally mounted in the ferrule internal mounting part 402 and fixed to the ferrule internal mounting part 402.

For the same reasons, to suppress the misalignment of the optical fiber 200 when the optical fiber 200 is held in the fiber holding part 401, it is desirable that the cross-sectional shape of the coating 202 of the optical fiber 200 and that of the fiber holding part 401 should be set suitably when the optical fiber 200 is held.

The photonic device mounting face of the ferrule 300 is not necessarily perpendicular to the optical axis of the optical fiber 200. For example, the photonic device mounting face of the ferrule 300 may be inclined from a direction perpendicular to the optical axis of the optical fiber 200. Inclining the photonic device mounting face in this way makes it possible to decrease the amount of reflected light from the end face 201a input to the planar photonic device 100. As a result, return optical noise from the planar photonic device 100 can be suppressed.

The planar photonic device 100 can also be mounted by ultrasonic bonding when Au bumps are used as photonic device mounting bumps 503 in addition to thermocompression bonding. As the photonic device mounting bumps 503, various materials and bonding methods, including solder bumps (thermal melting) and Sn/Cu bumps (solid-phase bonding), may be used in addition to Au bumps.

Multicomponent glass optical fiber or plastic optical fiber may be used as the optical fiber 200. The optical fiber 200 is not limited to a four-channel ribbon. The optical fiber 200 may have a suitable number of channels according to a communication system in which the optical module 100 is used.

As the materials for the ferrule 300 and sleeve 400, not only the epoxy resin but also polyphenylene sulfide (PPS), liquid-crystal polymer (LCP), polyamide resin, silicone resin, acrylic resin, or resin obtained by mixing polycarbonate resin with glass filler may be used.

The electric wiring 301 may be formed by embedding a lead frame in forming resin of the ferrule 300. While the electric wiring 301 has been formed only on the photonic device mounting face of the ferrule 300 in FIG. 2, it may formed so as to extend over another face of the ferrule 300, such as the top face or the bottom face of FIG. 2. Forming the electric wiring this way is effective in mounting the ferrule 300 on another substrate.

In addition, the first adhesive 501 and second adhesive 502 are not limited to thermosetting epoxy. Ultraviolet cure adhesive may be used as the first adhesive 501 and second adhesive 502.

### Second Embodiment

FIG. 9 is a sectional view showing a schematic configuration of an optical module according to a second embodiment.

An optical module 20 of the second embodiment differs from that of the first embodiment in that a part of the guide hole 302 in the ferrule 300 is tapered. Specifically, the size of a guide hole in a side facing the photonic device mounting face of the ferrule 300, that is, an end face on the sleeve side, is made larger than that of a hole in the photonic device mounting face of the ferrule 300.

With this structure, the size of the guide hole 302 closer to the side facing the photonic device mounting face of the ferrule 300 is larger than the end face 201a of the optical fiber 200. Therefore, the core line 201 of the optical fiber 200 held in the sleeve 400 can be inserted easily in the guide hole 302. Therefore, the second embodiment produces the effect of being capable of producing an optical module 20 in a short time in addition to the effect of the first embodiment.

### Third Embodiment

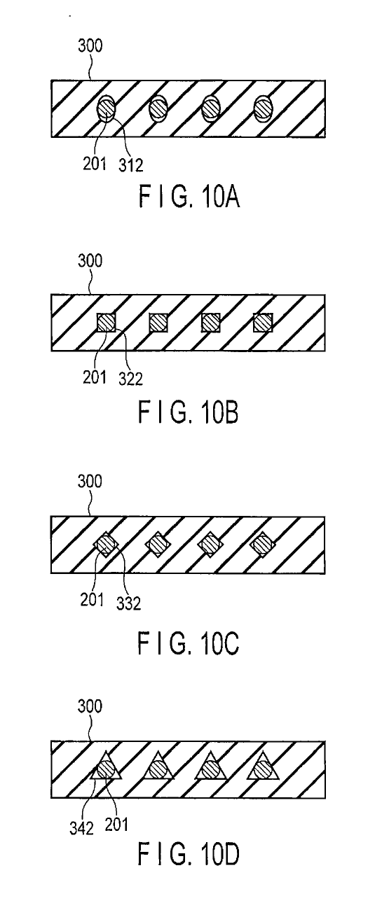

FIGS. 10A to 10D are sectional views showing configurations of ferrules to explain an optical module according to a third embodiment.

The third embodiment relates to modifications of the guide hole 302. Specifically, a guide hole 312 is made elliptical in FIG. 10A. A guide hole 322 is made quadrangular in FIG. 10B. A guide hole 332 is made rhombic in FIG. 10C. A guide hole 342 is made triangular in FIG. 10D. In the examples, an interspace is partially formed between the guide holes 312, 322, 332, 342 and the core line 201 of the optical fiber 200.

With this structure, it is easy to cause the second adhesive 502 to flow in the guide holes 312, 322, 332, 342. When there are air bubbles in the second adhesive 502 between the planar photonic device 100 and end face 201a, the efficiency of optical coupling between the planar photonic device 100 and the optical fiber 200 varies as compared with a case where there is no air bubble. The optical coupling characteristic might vary from channel to channel in the optical fiber 200. In contrast, providing an interspace as in the third embodiment enables air bubbles to be directed to the interspace through the expansion of the air bubbles when the second adhesive 502 is heat-hardened. This makes it possible to remove air bubbles between the planar photonic device 100 and the end face 201a.

The shapes of the guide holes 312, 322, 332, 342 are not necessarily to those of FIGS. 10A to 10D. They are arbitrary, provided that the alignment of the core line 201 in a direction of the optical axis of the optical fiber 200 can be performed.

### Fourth Embodiment

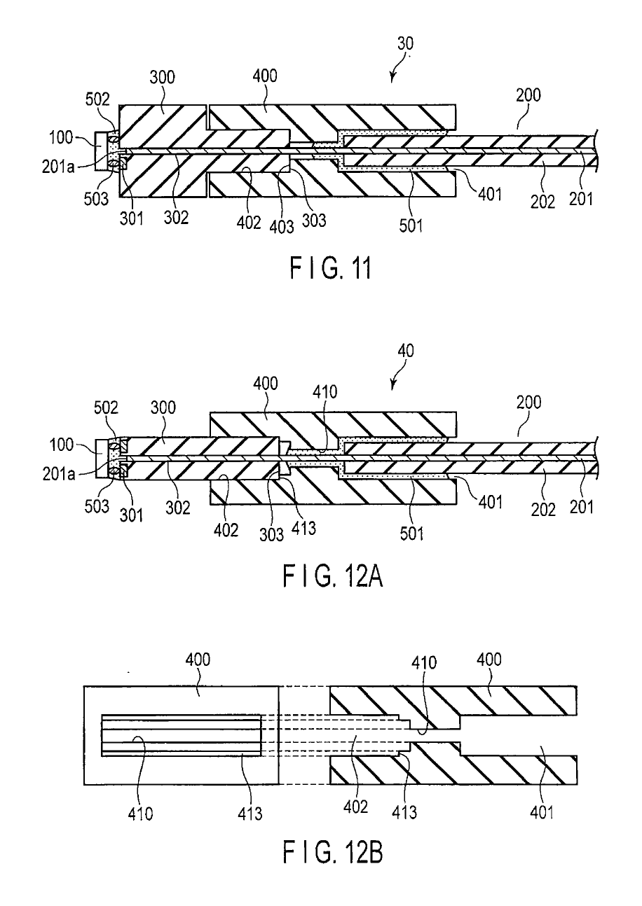

FIG. 11 is a sectional view showing a schematic configuration of an optical module according to a fourth embodiment.

An optical module 30 of the fourth embodiment is such that the thickness of the ferrule 300 is made almost equal to the thickness of the sleeve 400 and irregularities in the face mounted on a substrate or the like are removed. In addition, a part of the opposite side to the photonic device mounting face of the ferrule 300 is narrowed down to be thin so as to be internally mounted in the ferrule internal mounting part 402 of the sleeve 400.

With this configuration, it is easy to mount the optical module 30 on a substrate or the like. In addition, the mounting strength can be improved by increasing the mounting area. When the ferrule 300 is internally mounted in the sleeve 400, the side of the area not internally mounted in the ferrule internal mounting part 402 of the ferrule 300 may be pressed against the sleeve 400 earlier. In this case, too, the alignment of the ferrule 300 in a direction of the optical axis of the optical fiber 200 can be performed.

Furthermore, the size of the ferrule 300 may be made almost equal to that of the sleeve 400 not only in a longitudinal direction but also in a width direction. In this case, the outer shapes of them become almost equal. Therefore, the ferrule 300 and sleeve 400 can be put into a tool that has a cavity whose shape is made almost equal to the outer shapes of the ferrule 300 and sleeve 400, thereby fixing them to each other. That is, the fourth embodiment is characterized in that it is easier to insert the core line 201 of the optical fiber 200 in the guide hole 302.

### Fifth Embodiment

FIGS. 12A and 12B are diagrams to explain a schematic configuration of an optical module 40 according to a fifth embodiment. FIG. 12A is a sectional view showing an overall configuration and FIG. 12B is a schematic sectional view of a sleeve 400 and a schematic front view seen from a ferrule bumping part.

As in the first embodiment, an optical module 40 of the fifth embodiment comprises a planar photonic device 100, an optical fiber 200, a ferrule 300, and a sleeve 400. The optical module 40 of the fifth embodiment differs from the optical module 10 of the first embodiment in that a ferrule bumping part 413 is separate from the place of the smallest cross-sectional shape (the smallest cross-sectional part 410) perpendicular to the optical axis of the optical fiber 200 toward the ferrule 300 in the ferrule internal mounting part 402. Specifically, in the ferrule bumping part 413, a concave part whose vertical dimensions are smaller than those of the ferrule 300 is formed. In the bottom face of the concave part, a hole in the optical fiber holding part 401 is made.

When the optical fiber 200 is fixed to the fiber holding part 401 with a first adhesive 501, all of the smallest cross-sectional part 401 is filled with the first adhesive 501 by capillary action. The first adhesive 501 might protrude into the ferrule internal mounting part 402, running through the core line 201. The amount of the first adhesive 501 protruding varies from one optical module to another. Therefore, if this phenomenon has occurred in the optical module 10 of the first embodiment, the sleeve bumping part 303 of the ferrule 300 cannot be brought into direct contact with the ferrule bumping part 413 of the sleeve 400 to cause the sleeve bumping part 303 and ferrule bumping part 413 to butt each other. In this case, the alignment of the ferrule 300 in the optical axis direction cannot be performed. As a result, the alignment of the ferrule 300 in the optical axis direction cannot be performed accurately.

However, in the case of the optical module 40 of the fifth embodiment, the ferrule bumping part 413 is arranged at a distance greater than the amount of the first adhesive 501 protruding. With this arrangement, even if the first adhesive 501 has protruded into the ferrule internal mounting part 402, the sleeve bumping part 303 of the ferrule 300 can be brought into direct contact with the ferrule bumping part 413 of the sleeve 400 to cause the sleeve bumping part 303 and ferrule bumping part 413 to butt each other.

Therefore, the fifth embodiment not only produces the same effect as that of the first embodiment but also provides the advantage of capable of performing the alignment of the ferrule 300 and end face 201a in the optical axis direction accurately, regardless of the amount of the first adhesive 501 protruding.

### Sixth Embodiment

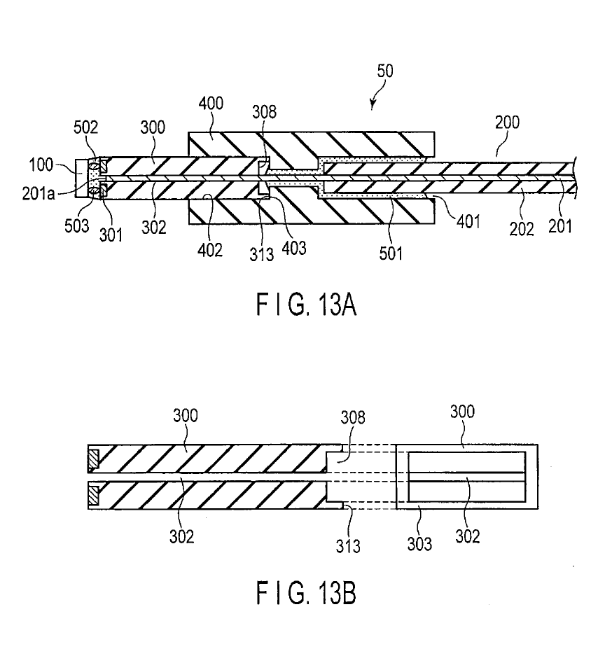

FIGS. 13A and 13B are diagrams to explain a schematic configuration of an optical module 50 according to a sixth embodiment. FIG. 13A is a sectional view showing an overall configuration. FIG. 13B is a schematic sectional view of a ferrule 300 and a schematic front view seen from a sleeve bumping part 302.

As in the first embodiment, the optical module 50 of the sixth embodiment comprises a planar photonic device 100, an optical fiber 200, a ferrule 300, and a sleeve 400. The optical module 50 of the sixth embodiment differs from the optical module 10 of the first embodiment in that the periphery of the guide hole 302 facing the mounting face of the ferrule 300 on which the planar photonic device 100 is mounted is separate from the place of the smallest cross-sectional shape (the smallest cross-sectional part 410) perpendicular to the optical axis of the optical fiber 200 in a fiber holding part 401. That is, a concave part 308 is formed so as to include an aperture of the guide hole 302 in the opposite face to the photonic device mounding face.

As described in the fifth embodiment, when the optical fiber 200 is fixed to the fiber holding part 401 with a first adhesive 501, all of the smallest cross-sectional part 410 is filled with the first adhesive 501 by capillary action. The first adhesive 501 might protrude into the ferrule internal mounting part 402, running through the core line 201. In this case, the sleeve bumping part 313 of the ferrule 300 cannot be brought into direct contact with the ferrule bumping part 403 of the sleeve 400 to cause the sleeve bumping part 313 and ferrule bumping part 403 to butt each other.

However, in the case of the optical module 50 of the sixth embodiment, the sleeve bumping part 313 is formed so as to avoid the first adhesive 501 protruding into the ferrule internal mounting part 402.

Therefore, the sleeve bumping part 313 can be caused to butt the ferrule bumping part 403 without making contact with the first adhesive 501. The shape of the periphery of the guide hole 302 facing the mounting face of the ferrule 300 on which the planar photonic device 100 is mounded is determined, taking into account the amount of the first adhesive 501 protruding into the ferrule internal mounting part 402.

Therefore, the sixth embodiment not only produces the same effect as that of the first embodiment but also provides the advantage of capable of performing the alignment of the ferrule 300 and end face 201a in the optical axis direction accurately, regardless of the amount of the first adhesive 501 protruding as the fifth embodiment does.

### Modification

The present invention is not limited to the above embodiments.

A planar photonic device, an optical fiber, a ferrule, a sleeve, and others constituting an optical module are not necessarily provided in such a manner that all of them are bonded and fixed. Since a planar photonic device and an optical fiber are to be mounted later, if there is a pair of a ferrule and a sleeve before bonding, an optical module explained in the embodiments can be produced.

The planar photonic device is not limited to a VCSEL. It is acceptable for the planar photonic device to be a planar light-emitting device that emits light in a direction perpendicular to the photonic device mounting face. In addition, a planar light-receiving device, such as a PIN photodiode, may be used as the planar photonic device.

Moreover, the sleeve need not necessarily have a hole through which an optical fiber is passed. It is acceptable for the sleeve to include a fiber holding part that holds an optical fiber and can be fixed with one end of the optical fiber protruding.

The optical module of the invention is not necessarily limited to a module on which a planar photonic device is mounted and may be so configured that a ferrule holding an optical fiber is merely fixed to a sleeve. In this case, the electric wiring of the ferrule can be omitted.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An optical module comprising:
an optical fiber;
a ferrule which has a guide hole for performing alignment in a direction perpendicular to the optical axis of the optical fiber;
a planar photonic device which is mounted on the ferrule; and
a sleeve which includes a holding part for holding the optical fiber and a bumping part for making contact with one end of the ferrule and to which the optical fiber and the ferrule are fixed,
wherein the optical fiber is fixed to the sleeve in such a manner that the optical fiber protrudes from one end of the sleeve and has an end face formed using one end of the sleeve as a reference, and
the optical fiber with the formed end face is inserted in the guide hole in the ferrule and the ferrule is fixed to the sleeve with one end of the ferrule in contact with the bumping part of the sleeve, thereby aligning the end face of the optical fiber with the planar photonic device in an optical axis direction.

2. The optical module of claim 1, wherein the ferrule has electric wiring formed at a face in which one aperture of the guide hole lies.

3. The optical module of claim 2, wherein the planar photonic device is connected to the electric wiring of the ferrule.

4. The optical module of claim 1, wherein a part of the periphery of the ferrule is internally mounted in a part of the sleeve, with one end of the ferrule fixed to the bumping part of the sleeve.

5. The optical module of claim 1, wherein the bumping part of the sleeve lies closer to the ferrule than an area where the inside diameter of a part of the sleeve holding the optical fiber is the smallest.

6. The optical module of claim 1, wherein a part of the ferrule caused to butt the sleeve lies closer to the sleeve than an end face on the sleeve side of the guide hole in which the optical fiber is inserted.

7. The optical module of claim 1, wherein a mounting face of the ferrule on which the planar photonic device is mounted-is inclined from a direction perpendicular to the optical axis of the optical fiber.

8. The optical module of claim 1, wherein the guide hole in the ferrule is in a tapered shape in such a manner that the size of the guide hole at the end face on the sleeve side is larger than the size on the planar photonic device mounting face side.

9. The optical module of claim 1, wherein the guide hole in the ferrule is elliptical, quadrangular, rhombic, or triangular.

10. An optical module comprising:
a ferrule which has a guide hole for performing alignment in a direction perpendicular to the optical axis of an optical fiber; and
a sleeve which includes a holding part that holds the optical fiber and a bumping part that makes contact with one end of the ferrule and to which the optical fiber and the ferrule are to be fixed,
wherein an end face of the optical fiber is capable of being formed using one end of the sleeve as a reference in such a manner that the optical fiber protrudes from one end of the sleeve and is fixed to the sleeve, and
the ferrule has one end kept contact with the bumping part of the sleeve and is fixed to the sleeve, with the optical fiber inserted in the guide hole.

11. The optical module of claim 10, wherein the ferrule has electric wiring formed at a face in which one aperture of the guide hole lies.

12. The optical module of claim 11, wherein the ferrule has a planar light-emitting device mounted on it and the planar light-emitting device is connected to the electric wiring.

13. The optical module of claim 10, wherein a part of the periphery of the ferrule is internally mounted in a part of the sleeve, with one end of the ferrule fixed to the bumping part of the sleeve.

14. The optical module of claim 10, wherein the bumping part of the sleeve lies closer to the ferrule than an area where the inside diameter of a part of the sleeve holding the optical fiber is the smallest.

15. The optical module of claim 10, wherein a part of the ferrule caused to butt the sleeve lies closer to the sleeve than an end face on the sleeve side of the guide hole in which the optical fiber is inserted.

16. The optical module of claim 12, wherein a mounting face of the ferrule on which the planar photonic device is mounted is inclined from a direction perpendicular to the optical axis of the optical fiber.

17. The optical module of claim 10, wherein the guide hole in the ferrule is in a tapered shape in such a manner that the size of the guide hole at the end face on the sleeve side is larger than the size on the planar photonic device mounting face side.

18. The optical module of claim 10, wherein the guide hole in the ferrule is elliptical, quadrangular, rhombic, or triangular.

19. An optical module manufacturing method comprising:
using a ferrule which has a guide hole for performing alignment in a direction perpendicular to the optical axis of an optical fiber and a sleeve which includes a holding part for holding the optical fiber and a bumping part for making contact with one end of the ferrule;
fixing the optical fiber to the sleeve in such a manner that the optical fiber is caused to protrude from one end of the sleeve;
forming an end face of the optical fiber fixed to the sleeve using one end of the sleeve as a reference;
not only inserting the optical fiber with the formed end face in the guide hole in the ferrule but also causing one end of the ferrule to make contact with the bumping part of the sleeve; and
fixing the ferrule to the sleeve, with one end of the ferrule in contact with the bumping part of the sleeve.
